(19) United States
(12) Patent Application Publication
(10) Pub. No.: US 2007/0160275 A1
(43) Pub. Date: Jul. 12, 2007

(54) Medical image retrieval

(76) Inventor: Shashidhar Sathyanarayana, Pleasanton, CA (US)

Correspondence Address: FISH & RICHARDSON P.C., PO BOX 1022, MINNEAPOLIS, MN, 55440-1022, US

(21) Appl. No.: 11/330,878

(22) Filed: Jan. 11, 2006

(51) Int. Cl. G06K 9/00

(52) U.S. Cl. 382/128

(57) ABSTRACT

Methods and systems for medical imaging are described. One implementation of the system includes an image acquisition subsystem configured to acquire medical images, an image analysis subsystem configured to analyze each acquired medical image and associate one or more descriptors with each acquired medical image based on the analysis, a database configured to store the acquired medical images and associated descriptors, and a query tool configured to search the database using descriptors.

### TECHNICAL FIELD

This invention relates to medical imaging.

### BACKGROUND

Medical personnel routinely use various medical imaging techniques, for example, ultrasound, MRI (magnetic resonance imaging), and x-rays, to create medical images. A physician or medical facility may accumulate a data store of medical images that are used both for current treatment of the corresponding patients and as a resource to draw upon for informational purposes.

IVUS (Intravascular Ultrasound) imaging is an exemplary medical imaging technique for creating images of the interior of a blood vessel. A conventional technique for generating a cross-sectional intravascular ultrasound (IVUS) image of a vessel involves sweeping an ultrasound beam sequentially in a 360-degree scan angle. A single element transducer at the end of a catheter can be rotated inside the vessel. Either the single element transducer can be attached to a flexible drive shaft or a rotating mirror can be used; in either case, the ultrasound beam is directed to substantially all angular positions within the vessel. Alternatively, a large number of small transducer elements can be mounted cylindrically at the circumference of the catheter tip, and the ultrasound beam steered electronically to form a cross-sectional scan.

The interaction of the ultrasound beam with tissue or blood yields an echo signal that is detected by the transducer. Based upon the biological medium that the echo signal interacts with, the echo signal can experience attenuation, reflection/refraction, and/or scattering. When an ultrasound wave travels across the boundary between two types of media, part of the wave is reflected at the interface, while the rest of the wave propagates through the second medium. The ratio between the reflected sound intensity and the intensity that continues through to the second medium is related to the difference in acoustic impedance between the mediums. An image processor draws a radial line corresponding to each angular position, and assigns brightness values to pixels on the line based on the echo received for that angular position. An IVUS system includes conversion circuitry to convert the echo signals described above into electronic signals capable of being displayed as an ultrasound image, e.g., in a standard video format.

Once formed, the IVUS image can be stored in a database, and later, can be retrieved from the database using any one of a variety of conventional image retrieval techniques. One technique, known as keyword-based image retrieval, retrieves images by matching keywords from a user query to annotations that have been manually generated and associated with the images. Another technique, known as content-based image retrieval, retrieves images based on the content of the image, rather than on annotations associated with the image. For example, using a content-based image retrieval, a user can search for an image that has a particular combination of colors.

### SUMMARY

This invention relates to medical imaging. In general, in one aspect, the invention features a computer-implemented method. The method includes receiving intravascular images, analyzing each intravascular image and associating one or more descriptors with each intravascular image based on the analysis, and storing the intravascular images and associated descriptors in a searchable data store. Each descriptor relates to a feature of the intravascular image.

Implementations of the invention can include one or more of the following features. A descriptor can be a textual descriptor, where the text describes the feature. In another implementation, the descriptor can be a symbol or code, where the symbol or code is mapped to a description of the feature. Analyzing each intravascular image can include comparing spectral characteristics of the intravascular image against a set of known spectral characteristics mapped to a set of descriptors. The feature can be a pathological feature, e.g., a tissue type. The intravascular images and descriptors can be stored in DICOM (Digital Imaging and Communications in Medicine) format. The intravascular images can be IVUS (Intravascular Ultrasound) images.

The method can further include performing a search of the data store based on the descriptors. The method can further include receiving an acquired intravascular image, analyzing the acquired intravascular image and associating one or more descriptors with the acquired intravascular image based on the analysis, and performing a search of the data store based on the one or more descriptors associated with the acquired intravascular image.

In general, in another aspect, the invention features another computer-implemented method. The method includes receiving an acquired intravascular image, analyzing the acquired intravascular image and associating one or more descriptors with the acquired intravascular image based on the analysis. A search of a collection of intravascular images is performed, and one or more intravascular images are retrieved from the collection. Each of the retrieved intravascular images is associated with at least one descriptor that matches a descriptor of the acquired intravascular image. The search is based on the one or more descriptors associated with the acquired intravascular image. Each descriptor relates to a feature of the acquired intravascular image.

Implementations of the invention can include one or more of the following features. A descriptor can be a textual descriptor, where the text describes the feature. In another implementation, the descriptor can be a symbol or code, where the symbol or code is mapped to a description of the feature. Analyzing the acquired intravascular image can include comparing spectral characteristics of the acquired intravascular image against a set of known spectral characteristics mapped to a set of descriptors. The feature related to a descriptor can be a pathological feature, e.g., a tissue type.

In general, in another aspect, the invention features an imaging system. The system includes an image acquisition subsystem, an image analysis subsystem, a database and a query tool. The image acquisition subsystem is configured to acquire medical images. The image analysis subsystem is configured to analyze each acquired medical image and associate one or more descriptors with each acquired medical image based on the analysis. The database is configured to store the acquired medical images and associated descriptors. The query tool is configured to search the database using descriptors. Each descriptor relates to a feature of the acquired medical image.

Implementations of the invention can include one or more of the following features. A descriptor can be a textual descriptor, where the text describes the feature. In another implementation, the descriptor can be a symbol or code, where the symbol or code is mapped to a description of the feature. The image analysis subsystem can be configured to compare spectral characteristics of the acquired medical image against a set of known spectral characteristics mapped to a corresponding set of descriptors. The feature related to a descriptor can be a pathological feature, e.g., a tissue type. The medical image can be an intravascular ultrasound image. The acquired medical images and associated descriptors can be stored in DICOM (Digital Imaging and Communications in Medicine) format.

In general, in another aspect, the invention features another computer-implemented method. The method includes receiving an acquired intravascular image, analyzing the acquired intravascular image to identify features of the image. If no features are identified by the analysis, then a content based search of the collection of intravascular images is performed. Otherwise, if any features are identified by the analysis, textual descriptors corresponding to the identified features are associated with the acquired intravascular image and a text based search of a collection of intravascular images is performed. If the text based search returns no images, then a content based search of the collection of intravascular images is performed. One or more textual descriptors is associated with each intravascular image. The text based search is based on the one or more textual descriptors of the acquired intravascular image.

Implementations can include one or more of the following features. Even if the text based search returns images, a content based search of the collection of intravascular images can be performed. In one implementation, the content based search of the collection of intravascular images includes the following steps. A spectral analysis of the acquired image is performed. A spectral analysis of each of the images in the collection of images is performed. The spectral analysis of the acquired image is compared to the spectral analysis of each of the images in the collection of images. Images are retrieved from the collection of images that have a spectral analysis meeting a predetermined threshold of similarity to the spectral analysis of the acquired analysis.

Implementations of the invention can realize one or more of the following advantages. A data store of medical images can be efficiently and thoroughly searched for images meeting a desired search criteria. The search criteria can be based on a set of descriptors, or can be initiated based on a source image. For example, a physician can quickly search a data store of previously acquired images to find images having pathological features matching or similar to an acquired source image. The search query can be automatically generated based on an automatic analysis of the source image, thereby limiting manual intervention. Images can be characterized according to pathological features present in the image, making it easier for the physician to evaluate the image.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an embodiment of a system including a searchable data store of medical images.

FIG. 2 illustrates an IVUS image.

FIG. 3 illustrates textual descriptors for an IVUS image.

FIG. 4 is a flowchart showing a process for storing images and associated textual descriptors in a data store.

FIG. 5 illustrates a marked IVUS image.

FIG. 6 is a flowchart showing a process for acquiring an image and searching a data store.

FIG. 7 is a flowchart showing an alternative process for acquiring an image and searching a data store.

FIGS. 8A, 8B, and 8C are graphs illustrating spectral characteristics of an image.

Like reference symbols in the various drawings indicate like elements.

### DETAILED DESCRIPTION

A method and system are described for creating and/or searching a data store of medical images. The data store, e.g., a database, includes a set of medical images (e.g., intravascular images), each having one or more corresponding descriptors associated with it. A search of the database can be performed using one or more descriptors to locate medical images associated with matching descriptors. The search can be based on arbitrary textual descriptors, or can be based on a descriptor associated with a source image for which similar images are sought to be retrieved.

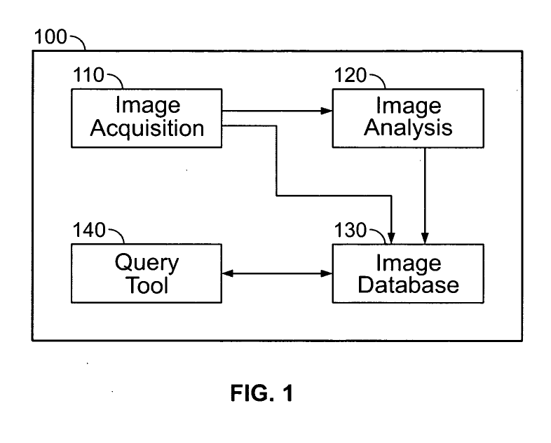

In one implementation, the medical images are intravascular images obtained using intravascular ultrasound, i.e., IVUS. FIG. 1 shows an exemplary system that can be used to search for intravascular images. In other implementations, the intravascular images can be obtained using other medical imaging techniques, for example, MRI (Magnetic Resonance Imaging).

In the implementation shown, the IVUS imaging system 100 includes an image acquisition subsystem 110, an image analysis subsystem 120, an image database 130, and a query tool 140. The image acquisition subsystem 110 acquires images using IVUS technology, for example, conventional IVUS technology as discussed above.

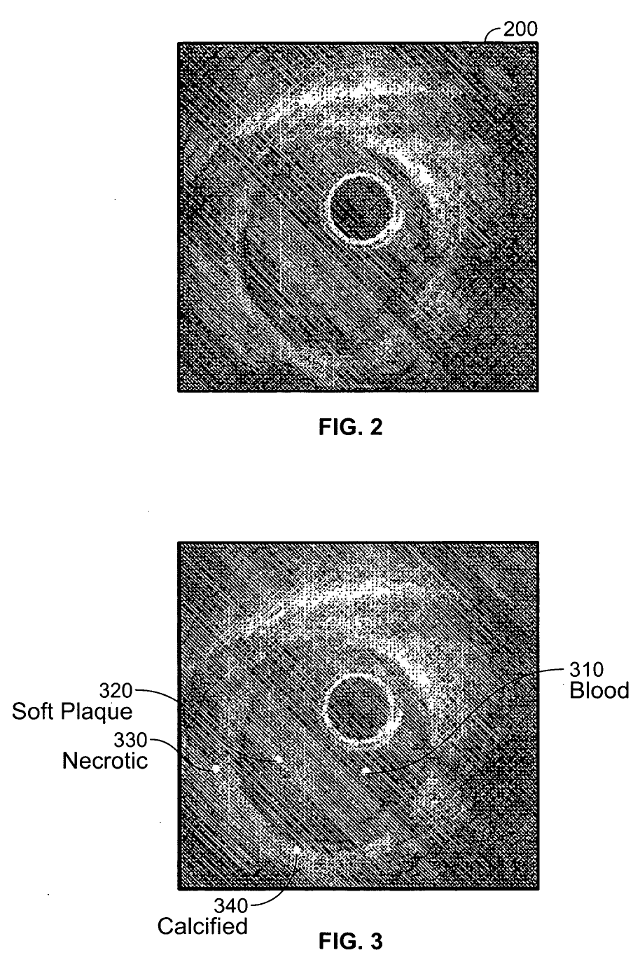

The image analysis subsystem 120 generates descriptors for the acquired images. In one implementation, the descriptors are textual descriptors, where the text included in the textual descriptor for a given image can describe features present in the image. For example, FIG. 2 illustrates an acquired image 200 and FIG. 3 illustrates textual descriptors 310, 320, 330, 340 generated for the acquired image 200. In this example, the features described by the textual descriptors are pathological features corresponding to different tissue types found in a blood vessel. These tissue types include: blood 310, soft plaque 320, necrotic 330, and calcified tissue 340.

Other types of descriptors can be used, and a textual descriptor is merely exemplary. A descriptor is searchable, e.g., can be searched for in a searchable database, and is related to a description of the corresponding feature. Thus, other forms of descriptors are possible. For example, a descriptor can be a symbol or a code (e.g., a numeric code), where the symbol or code is representative of a description of the feature. For example, symbols can be descriptive visually, providing an inherent description of the feature. As another example, a numeric code can be mapped to a textual description of the feature. For illustrative purposes, the methods and systems described herein are described in the context of textual descriptors. However, it should be understood that as just described, other forms of descriptors can be used, and the description below is described using textual descriptors for illustrative purposes only, and is not intended to be limiting.

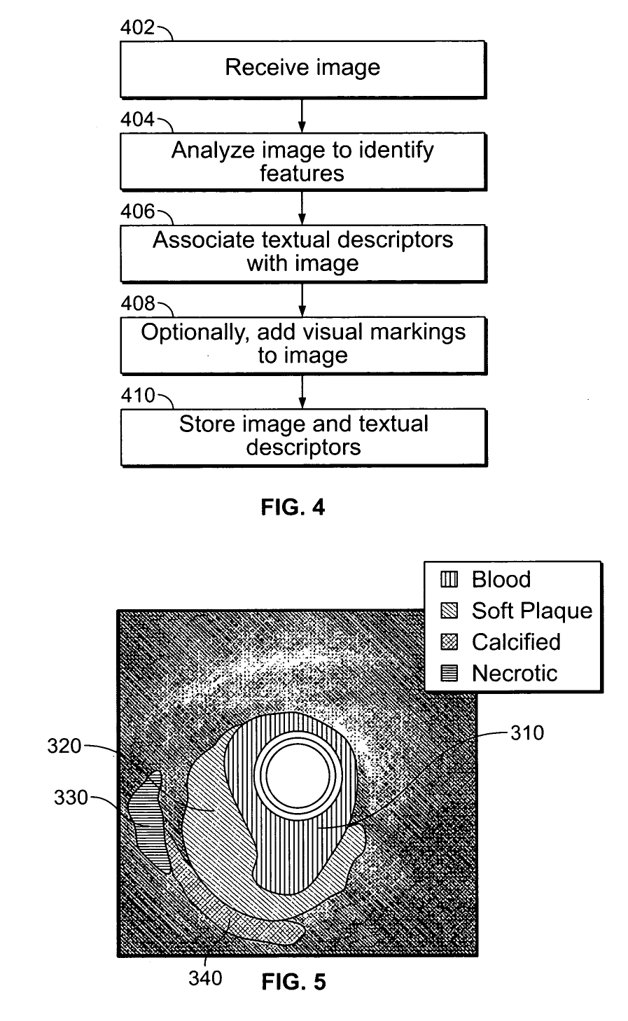

Referring again to FIG. 1, the textual descriptors are generated automatically, that is, without manual intervention. The image analysis subsystem 120 analyzes the image and generates textual descriptors based on the analysis. In one implementation, image recognition techniques are used to analyze the image, e.g., to identify features present in the image. For example, referring to FIG. 4, an image is received or acquired (step 402) and analyzed to identify features present in the image (step 404). In this implementation, the features are identified by first identifying spectral characteristics of the image and then comparing the identified spectral characteristics against information that maps spectral characteristics to features.

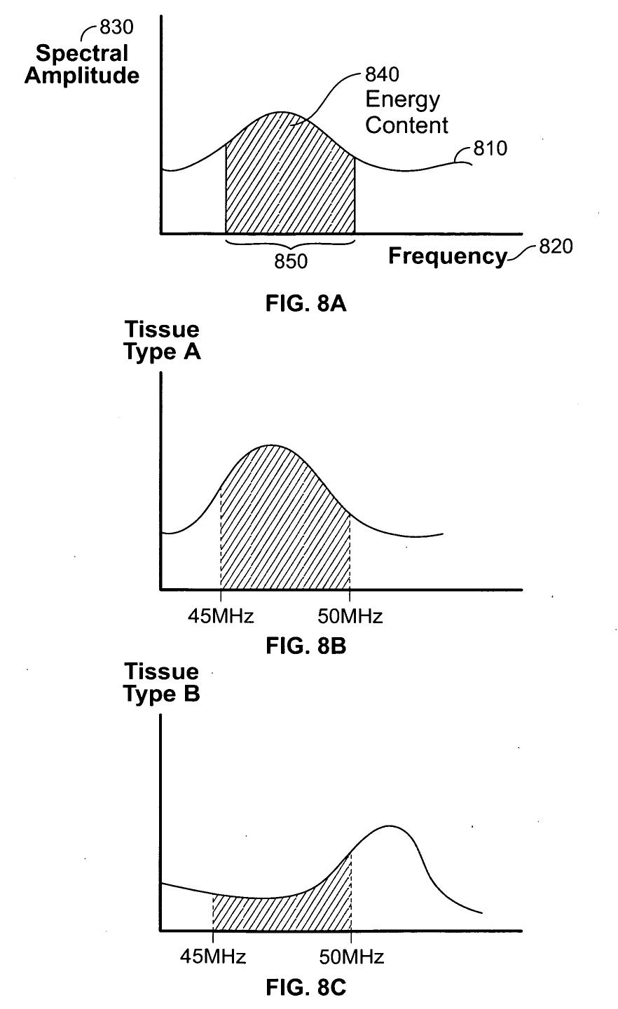

As described above, the image is generated based on acoustic signals (i.e., echoes) received by an ultrasound transducer. A spectral analysis of the image can be performed to identify spectral characteristics of the image. The acoustic signals are converted into electrical signals, which are then digitized. Referring to FIG. 8A, applying a Fourier transform to the digital signals, the digital signals can be expressed as a function of frequency 820 and spectral amplitude 830. The area 840 beneath the curve 810 representing the digital signals for a given frequency range 850 represents the energy content for that frequency range. The energy content for a given frequency range varies from tissue type to tissue type, and therefore for each tissue type can be used as a “spectral signature”. The spectral signature can thereby be used to identify tissue types present in a given image.

As shown in FIGS. 8B and 8C, different tissue types have different spectral signatures. In the example shown, tissue type A has a much higher energy content than tissue type B for the frequency range of 45 to 50 megahertz. Thus, for a given signal, if the energy content within the frequency range of 45 to 50 megahertz is higher than a certain threshold value, then the signal is determined to correspond to tissue type A.

In one implementation, multiple digital signals corresponding to multiple angular positions (i.e., along multiple radial lines) of the ultrasound transducer within the vessel are analyzed. The tissue types detected along a radial line tend to correspond to the tissue types detected along adjacent radial lines, and together provide an indication of the tissue types present in the cross section of the vessel being imaged. For example, as shown in FIG. 5, the different tissue types detected along the multiple radial lines together provide a visual representation of the tissue types present at the cross section of the vessel shown in the image. In one implementation, a radial line, in its digitized representation, consists of approximately 2000 samples. Depending on the sampling rate and the velocity of ultrasound in the tissue (e.g., 1500 meters/second), each sample can be associated with a particular radial distance. Along a radial line, e.g., radial line 500 shown in FIG. 5, a localized region of a certain tissue type, e.g., soft plaque, can translate to a subsequence within the complete 2000 sample sequence making up the radial line. A spectrum can be found using the samples in the subsequence, and the corresponding spectral amplitude versus frequency graph can be associated with a distance corresponding to a sample (e.g., the middle sample) in the subsequence.

In other implementations, different transforms can be applied to the digital signals, and the Fourier transform is described above for illustrative purposes. For example, the transform can be a problem-specific transform, i.e., a transform that is customized for a specific class of data. One example of a problem-specific transform is the Fisher Linear Discriminant.

In one implementation, the information mapping spectral characteristics to features is stored in a lookup table. A mapping can be based on a match, where the match is either a direct match, a closest match, or a match within a predetermined range (i.e., a spectral characteristic that is +/− a certain amount from a lookup value is considered a match). The lookup table can also include one or more textual descriptors corresponding to each feature. Alternatively, the textual descriptors can be stored in a second lookup table that maps the features of the first lookup table to textual descriptors. One or more textual descriptors are associated with the image based on the features identified (step 406).

The lookup table can be constructed during a system calibration process that is performed prior to the deployment and use of the system 100 for productive purposes. The lookup table can be constructed by examining a representative sample of images including a set of known features, and identifying the spectral characteristics that correspond to the features. In one implementation, the images used to calibrate the system can be provided as part of the system 100. That is, the calibration images can form a “reference library” of images that can be retrieved by a user of the system, in addition to any other images that the user adds to his/her own database 130.

In addition to generating the textual descriptors for a given image, the image analysis subsystem 120 optionally can also add visual markings to the image to characterize the various features identified (step 408). For example, as illustrated in FIG. 5, each portion of the image that corresponds to a different feature is represented in a different color or pattern, e.g., the calcified region 340 is shown cross-hatched. This visual characterization of the different features can make it easier for a user to evaluate the image. Optionally, additional information, for example, information provided by the user, can be added to the image.

The images and the associated textual descriptors are stored in the image database 130 (step 410). In one implementation, the images and textual descriptors are stored in DICOM format. DICOM, an acronym for Digital Imaging and Communications in Medicine, is a standard developed by ACR—NEMA (American College of Radiology—National Electrical Manufacturer's Association) for storing and transmitting medical image data. A typical DICOM file includes a header with standardized as well as free-form fields and a body of image data. The acquired image can be included in the body of the file and the associated textual descriptors can be included in the file header. The file header can also include other contextual information besides the textual descriptors, for example, a timestamp corresponding to the time and date when the image was acquired, and a patient identification code.

The query tool 140 allows a user to search the image database 130. In one implementation, the search is initiated by providing the query tool 140 with one or more search terms. For example, a physician may want to know: “How did patient X's blood vessel look when I tested him last year?”. The physician can use a search query that includes the patient's name, a date range and a textual descriptor describing the tissue type or blood vessel type the physician is looking for. The physician may want to know: “How does patient X's blood vessel compare with others I have encountered in the last year?” In this example, the search query can include a date range and a textual descriptor describing the tissue type or blood vessel type and exclude images belonging to patient X. Such queries can be made by entering search terms into one or more search fields (e.g., patient name, patient ID, date range, vessel type). Alternatively, more sophisticated search technology can be used allowing the physician to simply input the questions as stated above into a search field, i.e., “How does patient X's blood vessel type compare with others I have encountered in the last year?”, and an appropriate search query automatically generates to retrieve comparable images.

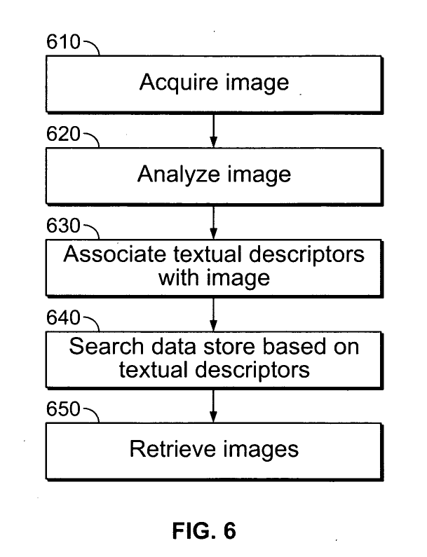

In another implementation, the search can be initiated by first acquiring a source image and then searching for images similar to the source image. As shown in FIG. 6, an image is acquired (step 610) and analyzed (step 620). One or more textual descriptors are associated with the acquired image based on the analysis (step 630). A search of the image database 130 is then performed based on the textual descriptors associated with the acquired image (step 640). Images are retrieved from the image database 130 (step 650). Each of the retrieved images has at least one associated textual descriptor that matches one of the textual descriptors of the acquired image.

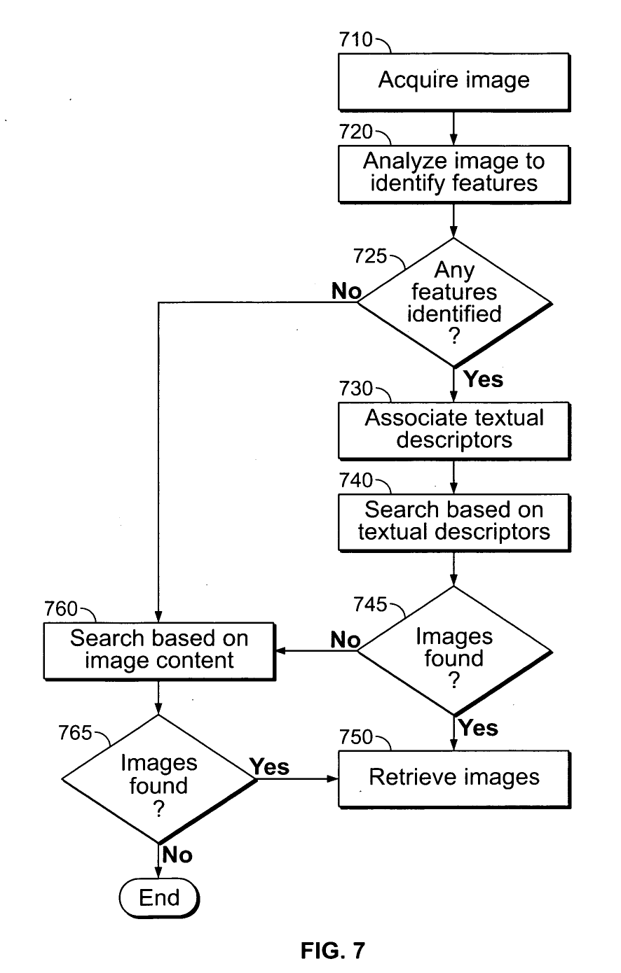

In another implementation, the system 100 can be configured to perform a content based search in addition to, or in place of, the text based search (i.e., search using textual descriptors). Referring to FIG. 7, in this implementation, an image is acquired (step 710) and analyzed to identify features present in the image (step 720). If no features are identified (i.e., no features that correspond to those included in a look-up table) (“No” branch of decision step 725), then a content based search is performed (step 760), as will be described in more detail below. If one or more features are identified (“Yes” branch of decision step 725), then one or more textual descriptors corresponding to the identified features are associated with the acquired image (step 730). A search of the image database 130 is then performed based on the textual descriptors associated with the acquired image (step 740). If matching images are found based on the textual descriptors (“Yes” branch of decision step 745), then the matching images are retrieved from the image database 130 (step 750).

Otherwise, if no matching images are found based on the one or more textual descriptors (“No” branch of decision step 745), then the query tool performs another search, but this time, based on the content of the images, instead of on the textual descriptors (step 760). The content based search can be performed using conventional content-based image retrieval techniques. For example, one or more spectral signatures of the acquired image can be identified from the analysis step. Then each image included in the database 130 can be analyzed and corresponding spectral signatures for said images determined. The spectral signatures of the images in the database 130 can be compared to the spectral signature of the acquired image. If the spectral signatures match (i.e., are similar within a predetermined threshold), then the images are retrieved as matching images (step 750). The content-based search is less efficient then a search based on textual descriptors, as each image in the database 130 must be analyzed, as compared to only analyzing the acquired image if doing a search based on textual descriptors. However, the content-based search allows the query tool to find images containing features that are not contained in the lookup table used by the image analysis subsystem 120.

In another implementation, even if images are found based on the textual descriptors, a second content-based search can be performed to capture other images that have matching features that are not included in the look-up table.

Similarly, referring again to decision step 725, if no features are identified, and therefore no textual descriptors are associated with the image, then a content-based search as described above can be performed (step 760), and if matching images are found (“Yes” branch of decision step 765), they are retrieved (step 750).

A subsystem, as the term is used throughout this application, can be a piece of hardware that encapsulates a function, can be firmware or can be a software application. A subsystem can perform one or more functions, and one piece of hardware, firmware or software can perform the functions of more than one of the subsystems described herein. Similarly, more than one piece of hardware, firmware and/or software can be used to perform the function of a single subsystem described herein.

The functional operations of some or all of the subsystems described in this specification can be implemented in digital electronic circuitry, or in computer software, firmware, or hardware, including the structural means disclosed in this specification and structural equivalents thereof, or in combinations of them. The processes described can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers.

A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed (at least in part) by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For exampled, the images can be obtained using other imaging technology besides ultrasound imaging, for example, MRI (Magnetic Resonance Imaging) technology. The logic flows depicted in FIGS. 4, 6 and 7 do not require the particular order shown, or sequential order, to achieve desirous results, and the steps of the invention can be performed in a different order. Accordingly, other embodiments are within the scope of the following claims.

What is claimed is:

1. A computer-implemented method comprising:
receiving a plurality of intravascular images;
analyzing each intravascular image and associating one or more descriptors with each intravascular image based on the analysis, where each descriptor relates to a feature of the intravascular image; and
storing the intravascular images and associated descriptors in a searchable data store.

2. The computer-implemented method of claim 1, where the one or more descriptors comprise textual descriptors and where each textual descriptor includes texts describing the related feature.

3. The computer-implemented method of claim 1, where the one or more descriptors comprise symbolic descriptors and where each symbolic descriptor provides a visual description of the related feature or is mapped to a textual description of the related feature.

4. The computer-implemented method of claim 1, where analyzing each intravascular image comprises comparing spectral characteristics of the intravascular image against a set of known spectral characteristics mapped to a set of textual descriptors.

5. The computer-implemented method of claim 1, where the feature is a pathological feature.

6. The computer-implemented method of claim 5, where the pathological feature is a tissue type.

7. The computer-implemented method of claim 1, where the intravascular images and descriptors are stored in DICOM (Digital Imaging and Communications in Medicine) format.

8. The computer-implemented method of claim 1, where the intravascular images are IVUS (Intravascular Ultrasound) images.

9. The computer-implemented method of claim 1, further comprising:
performing a search of the data store based on one or more descriptors.

10. The computer-implemented method of claim 1, further comprising:
acquiring an intravascular image;
analyzing the acquired intravascular image and associating one or more descriptors with the acquired intravascular image based on the analysis; and
performing a search of the data store based on the one or more descriptors associated with the acquired intravascular image.

11. A computer-implemented method comprising:
receiving an acquired intravascular image;
analyzing the acquired intravascular image and associating one or more descriptors with the acquired intravascular image based on the analysis, where each descriptor relates to a feature of the acquired intravascular image;
performing a search of a collection of intravascular images, each intravascular image associated with one or more descriptors, where the search is based on the one or more descriptors of the acquired intravascular image; and
retrieving one or more intravascular images from the collection, where each of the retrieved intravascular images is associated with at least one descriptor that matches a descriptor of the acquired intravascular image.

12. The computer-implemented method of claim 11, where the one or more descriptors comprise textual descriptors and where each textual descriptor includes texts describing the related feature.

13. The computer-implemented method of claim 11, where the one or more descriptors comprise symbolic descriptors and where each symbolic descriptor provides a visual description of the related feature or is mapped to a textual description of the related feature.

14. The computer-implemented method of claim 11, where analyzing the acquired intravascular image comprises comparing spectral characteristics of the acquired intravascular image against a set of known spectral characteristics mapped to a set of descriptors.

15. The computer-implemented method of claim 11, where the feature is a pathological feature.

16. The computer-implemented method of claim 15, where the pathological feature is a tissue type.

17. The computer-implemented method of claim 11, where the intravascular images are IVUS (Intravascular Ultrasound) images.

18. An imaging system comprising:
an image acquisition subsystem configured to acquire medical images;
an image analysis subsystem configured to analyze each acquired medical image and associate one or more descriptors with each acquired medical image based on the analysis, where each descriptor relates to a feature of the acquired medical image;
a database configured to store the acquired medical images and associated descriptors; and
a query tool configured to search the database using one or more descriptors.

19. The system of claim 18, where the one or more descriptors comprise textual descriptors and where each textual descriptor includes texts describing the related feature.

20. The system of claim 18, where the one or more descriptors comprise symbolic descriptors and where each symbolic descriptor provides a visual description of the related feature or is mapped to a textual description of the related feature.

21. The system of claim 18, where an image analysis subsystem configured to analyze each acquired medical image comprises an image analysis subsystem configured to compare spectral characteristics of the acquired medical image against a set of known spectral characteristics mapped to a corresponding set of textual descriptors.

22. The system of claim 18, where the feature is a pathological feature.

23. The system of claim 18, where the medical image is an intravascular ultrasound image.

24. The system of claim 18, where the acquired medical images and associated textual descriptors are stored in DICOM (Digital Imaging and Communications in Medicine) format.

25. A computer-implemented method comprising:
receiving an acquired intravascular image;
analyzing the acquired intravascular image to identify features of the image;
if any features are identified by the analysis,
associating textual descriptors corresponding to the identified features with the acquired intravascular image;
performing a text based search of a collection of intravascular images, each intravascular image associated with one or more textual descriptors, where the text based search is based on the one or more textual descriptors of the acquired intravascular image; and
if the text based search returns no images, performing a content based search of the collection of intravascular images;
otherwise, if no features are identified by the analysis,
performing a content based search of the collection of intravascular images.

26. The computer-implemented method of claim 25, where the intravascular images are IVUS (Intravascular Ultrasound) images.

27. The computer-implemented method of claim 25, further comprising, even if the text based search returns images, performing a content based search of the collection of intravascular images.

28. The computer-implemented method of claim 25, where the content based search of the collection of intravascular images comprises:
performing a spectral analysis of the acquired image;
performing a spectral analysis of each of the images in the collection of images;
comparing the spectral analysis of the acquired image to the spectral analysis of each of the images in the collection of images; and
retrieving images from the collection of images that have a spectral analysis meeting a predetermined threshold of similarity to the spectral analysis of the acquired analysis.
